(19) United States
(12) Patent Application Publication
(10) Pub. No.: US 2005/0289484 A1
(43) Pub. Date: Dec. 29, 2005

(54) Externalization of coil structure patterns

(76) Inventors: Kevin J. Whitefoot, Svelvik (NO); John P. McInerney, Centertown, MO (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/876,213

(22) Filed: Jun. 24, 2004

(51) Int. Cl. G06F 17/50

(52) U.S. Cl. 716/1

(57) ABSTRACT

A user can create a coil structure pattern on a display screen and annotate it with information such as comments, key values, and script fragments. Generating a coil structure pattern comprises receiving at least one pattern or sub-pattern, and assembling a layout comprising the pattern or sub-pattern. A parameter value, attribute, and/or metadata is provided to the pattern or sub-pattern disposed in the assembled layout, and a coil structure pattern is generated based on the layout and the parameter value, attribute, and/or metadata. The coil structure pattern may be stored in a storage device. A coil pattern creation system comprises a storage device storing a pattern and/or a sub-pattern; a pattern design system for receiving a pattern and/or sub-pattern from the storage device and assembling a layout comprising the pattern and/or sub-pattern; and a user interface coupled to the pattern design system for providing a parameter value, an attribute, and/or metadata to the pattern and/or sub-pattern disposed in the assembled layout. The pattern design system generates a coil structure pattern based on the layout and the parameter value, attribute, and/or metadata. Previously generated coil structure patterns, or parts of the patterns, may be stored and re-used.

### FIELD OF THE INVENTION

This invention relates in general to the field of circuit design. More particularly, this invention relates to coil structure patterns used in design of electrical devices.

### BACKGROUND OF THE INVENTION

Coil structure patterns are used in the creation of coils for electrical devices such as transformers or other products. Currently, all coil structure patterns are manually programmed or use a cumbersome user interface requiring manual intervention. As a result, a programmer, in conjunction with a product designer, must collaborate to produce a new coil structure pattern. When creating coil structure patterns in a conventional system, it is difficult to ensure that patterns are correct. Moreover, it is difficult for the product designer to communicate to the programmer all the details needed to capture the coil structure pattern in software. A further problem is that the existing techniques do not permit re-use of parts of a coil structure pattern. Many patterns are similar, which creates a maintenance problem when part of a pattern that is included in other patterns must be corrected or otherwise changed.

In view of the foregoing, there is a need for systems and methods that overcome the limitations and drawbacks of the prior art.

### SUMMARY OF THE INVENTION

The present invention is directed systems and methods that allow a user to create a coil structure pattern on a display screen and to annotate it with information such as comments, key values, and script fragments.

An exemplary method of generating a coil structure pattern comprises receiving at least one pattern or sub-pattern, and assembling a layout comprising the pattern or sub-pattern. A parameter value, attribute, and/or metadata is provided to the pattern or sub-pattern disposed in the assembled layout, and a coil structure pattern is generated based on the layout and the parameter value, attribute, and/or metadata. The coil structure pattern may be stored in a storage device.

An exemplary coil pattern creation system comprises a storage device storing a pattern and/or a sub-pattern; a pattern design system for receiving a pattern and/or sub-pattern from the storage device and assembling a layout comprising the pattern and/or sub-pattern; and a user interface coupled to the pattern design system for providing a parameter value, an attribute, and/or metadata to the pattern and/or sub-pattern disposed in the assembled layout. The pattern design system generates a coil structure pattern based on the layout and the parameter value, attribute, and/or metadata.

According to aspects of the invention, previously generated coil structure patterns, or parts of the patterns, may be stored and re-used.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram of an exemplary coil structure pattern creation system in accordance with the present invention;

FIG. 2 is a flow diagram of an exemplary method of generating a coil structure pattern in accordance with the present invention;

FIG. 3 is a diagram of an exemplary coil structure pattern layout that may be generated in accordance with the present invention;

FIG. 4 is a diagram of an exemplary circuit schematic that may be generated in accordance with the present invention; and

FIG. 5 is a diagram of an exemplary database design in accordance with the present invention.

### DETAILED DESCRIPTION OF ILLUSTRATIVE EMBODIMENTS

A coil structure pattern is generated for a coil that may be used in a device such as a transformer. Various objects pertaining to the coil structure pattern are arranged on the screen automatically so the user can concentrate on the information that he is providing.

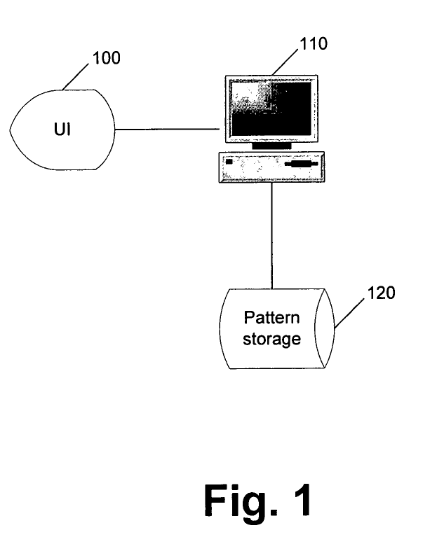

FIG. 1 is a block diagram of an exemplary coil structure pattern creation system in accordance with the present invention. A user interface 100 is coupled to a pattern design system 110. The pattern design system 110 has access to a storage device 120 that stores previously generated patterns as well as newly created patterns. A user, via the user interface 100 in conjunction with a monitor or display associated with the pattern design system, may design a pattern, such as a coil structure pattern for a transformer. Any conventional device or technique for providing fundamental services such as menus and basic drawing facilities may be employed.

More particularly, the graphical user interface 100 enables a user to define spatial and electrical circuit relationships among various pattern elements to create a new structure, such as a pattern, dynamically. A pattern typically comprises elements such as a circuit set, a circuit schematic, and a circuit layout.

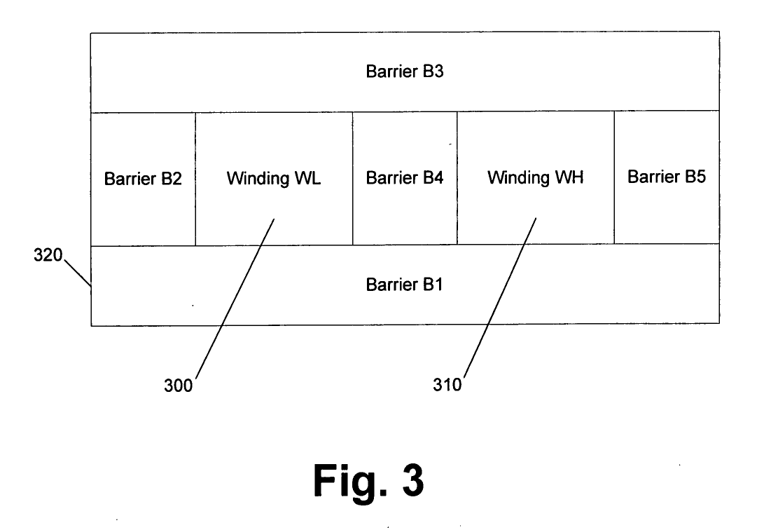

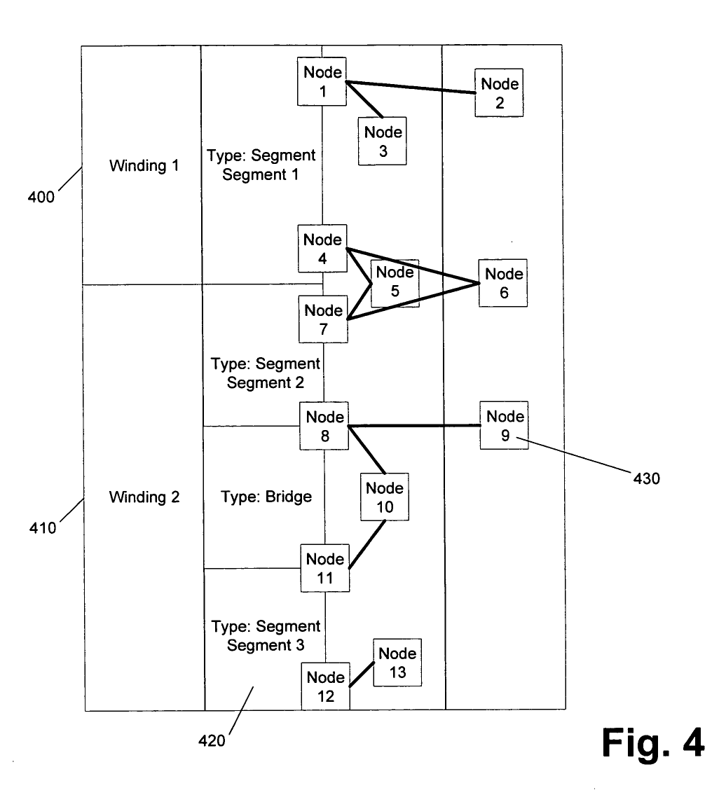

A circuit layout is provided (e.g., on a monitor associated with the pattern design system 110) to show how the elements that ultimately make up the underlying coil (e.g., a transformer coil) are physically connected to each other. A circuit schematic diagram shows how the elements are connected together electrically. A circuit set comprises a list of pairs of circuit layouts and circuit schematics. A pattern is created at runtime, and is desirably stored in storage 120, e.g., in the form of a database. Exemplary portions of an exemplary circuit layout are shown in FIGS. 3 and 4. FIG. 3 shows an exemplary physical layout, and FIG. 4 shows an exemplary electrical layout. Many combinations of physical and electrical circuits may be stored in a storage device associated with a computer, and the combination of two or more of the circuits form a coil and comprise a circuit set. Circuit sets may comprise one or more stored combinations together to define a coil.

A user such as a product designer can access the pattern design system 110 via the user interface 100 to graphically create the pattern using an input device (e.g., a mouse) to drag and drop elements into the desired relationships with each other. Each element has associated attributes that the user may edit. These attributes include references to existing sub-patterns (e.g., circuit schematics, circuit layouts), and script fragments that are to be used when the pattern is accessed to create an actual transformer coil. Such script fragments may determine the values of certain attributes of the coil. The sub-patterns may have been previously created and stored (e.g., in the storage device 120 or elsewhere).

The user may also add metadata to the pattern to assist both a human user and a software program to find a pattern suitable for a specific transformer specification. Thus, the metadata elements allow other programs or persons to search the database of patterns.

After the user has created the pattern on the screen and annotated it as desired, the pattern is desirably converted into an internal form suitable for saving to the storage device 120. It is contemplated that any database management system may be used to store the patterns. Facilities are desirably provided to read the pattern from the storage device 120, display it on a screen associated with the design system 110, and allow the user to edit it if desired and re-save. Patterns and parts of patterns may also be copied and renamed to facilitate re-use.

The pattern and sub-pattern data that is stored in the storage device 120 can be used at design time to create a new structure, such as a coil structure. The user can add script fragments to the various parts of the pattern which are then used to determine the values of certain attributes dependent on the specification of the specific transformer being designed. This reduces the number of patterns that are designed and stored. The pattern can also contain sub-patterns. The choice of sub-pattern to be applied can be made automatically at transformer design time based on the specification of the transformer being designed and the attributes of the various sub-patterns. This further reduces the number of distinct patterns that are designed and stored.

In particularly, parts of patterns, such as circuit layouts or circuit schematics, can be reused both within a given pattern and as component parts of multiple patterns. This reduces the number of patterns to be created and maintained, and makes it easier to be certain that a pattern is correct. The provision of multiple sub-patterns within a given pattern further reduces the number of patterns to be designed. For example, two or more transformers that differ in only one circuit can be represented by the same pattern.

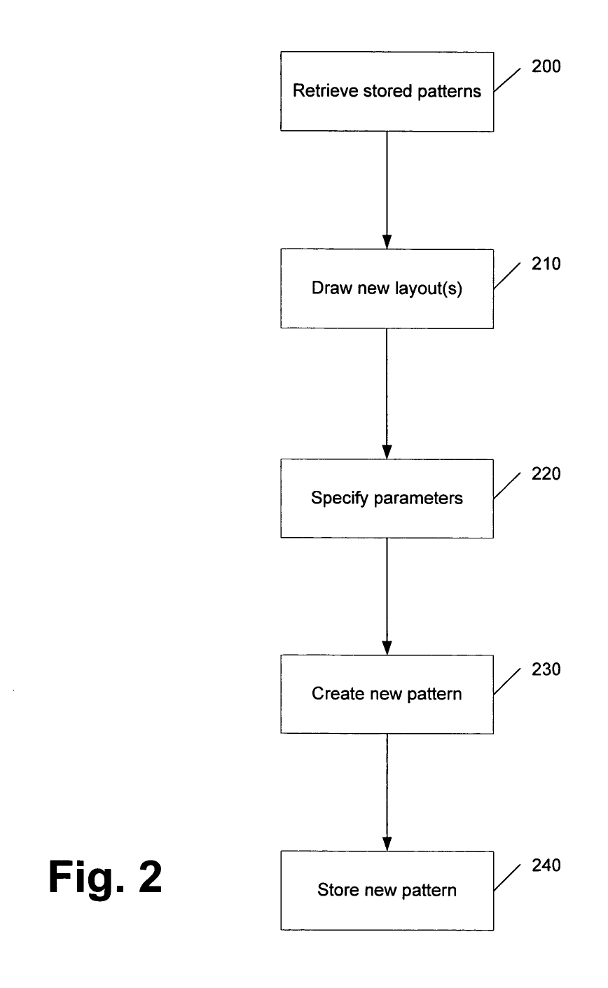

FIG. 2 is a flow diagram of an exemplary method of generating a coil structure pattern in accordance with the present invention. At step 200, stored patterns or sub-patterns, if desired, are retrieved from storage at design time. These retrieved patterns or sub-patterns may then be used in the design of a new layout. At step 210, the new layout is assembled (e.g., drawn) on the screen via the user interface. The new layout may comprise elements as well as previously stored patterns and/or sub-patterns.

More than one circuit layout and circuit schematic may be included in a given pattern. This allows the user to specify a pattern that will allow the actual physical layout to be determined automatically at runtime from a menu of allowed types. The runtime process determines which layout and schematic to use based on the specification of the device (e.g., transformer) to be designed.

At step 220, parameters and/or other attributes are added to the layout elements. Any type of metadata could be added to the patterns to allow for searching on the stored patterns. Although some data items may be mandatory, it is contemplated that the user could add any number of key-value pairs to the pattern so that the patterns could be listed, sorted or categorized according to criteria that were meaningful or otherwise desirable to the end user. Mandatory metadata may comprise a pattern identifier which is used to identify the pattern, a pattern description which describes the definition of the pattern, a pattern type which is either a coil pattern or circuit pattern, a number of nominal voltages supported by the pattern, and the product type, which defines in which transformer products the pattern can be used. Other metadata is optional. Thus, the system does not have to anticipate every possible way of categorizing a pattern. Examples of parameter names and definitions include: product family, product group, application limitations such as coil voltage limits, power restrictions, etc.

The new pattern is thus created at runtime based on the layout elements (including any pre-existing patterns and sub-patterns), parameters, and attributes, at step 230. Moreover, the use of scripts allows the runtime process to determine values of coil attributes based on values obtained from the specification of the particular transformer being designed. The newly created pattern is stored in a storage device at step 240.

FIG. 3 is a diagram of an exemplary coil structure pattern layout that may be generated in accordance with the present invention. In this example, a physical layout of the winding and barrier elements of a coil is provided. The winding elements 300, 310 are surrounded by various barrier elements 320. WL 300 refers to the low voltage winding, and WH 310 refers to the high voltage winding. It should be noted that this layout shows the relationships between the elements, but not the actual sizes. This figure represents a cross sectional view of one leg of an exemplary coil structure.

FIG. 4 is a diagram of an exemplary circuit schematic that may be generated in accordance with the present invention. Two winding elements 400, 410 are provided with associated segments and bridges 420. The winding element 400 has one associated segment, and the winding element 410 has two segments separated by a bridge. The bridge is a non-conducting segment. Various nodes 430 are provided. It should be noted that this circuit schematic is unrelated to the physical layout. This figure depicts a standard electrical engineering electrical circuit node diagram, showing how the individual parts of windings are connected to produce one of the voltages specified as a property of a coil as an input from the customer.

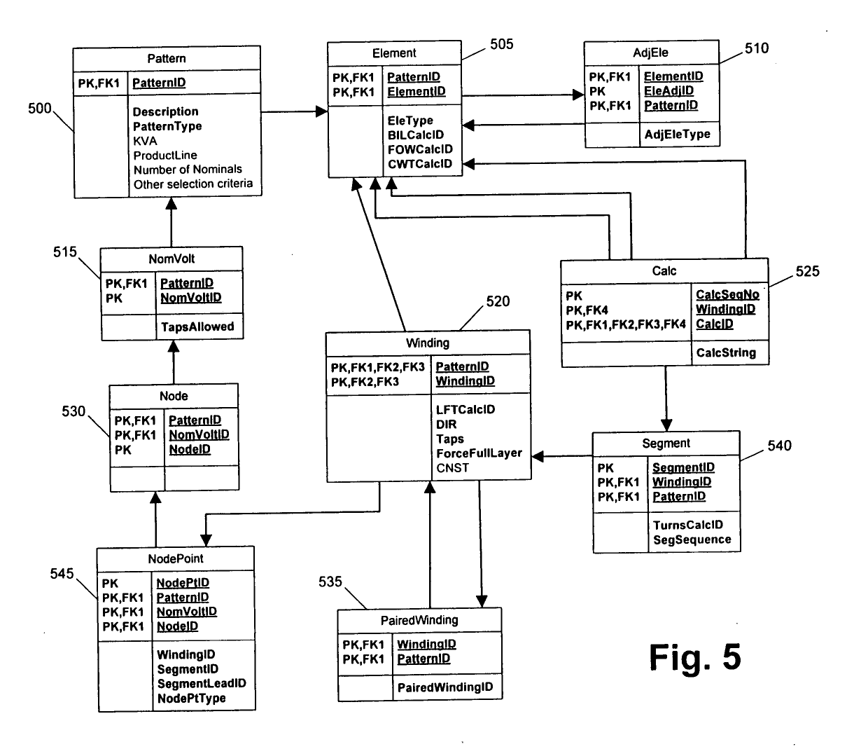

FIG. 5 is a diagram of an exemplary database design in accordance with the present invention. The exemplary database design may be employed in the pattern storage device (e.g., the storage device 120 in FIG. 1). The pattern is defined by this data. FIG. 5 shows the relationships between the various tables in the database. Keys in each table link the tables in the database in such a manner that the data is accessible once the pattern id is known.

A pattern table 500 is stored with data such as an identifier, a type, product line, number of nominals, and other information that could used in subsequent selection. The pattern table 500 desirably is the initial entry into the series of tables, and navigation through the database starts with the pattern table 500. A nominal voltage table 515, pertaining to the pattern may also be stored. The nominal voltage table 515 specifies how many nominal voltages are allowed in the coil circuit and whether or not taps are allowed for each nominal voltage. A node table 530 is a relationship table that links each nominal voltage to one or more node point records in a node point table 545. The node point table 545 contains the node point data and links to a winding record in a winding table 520. A paired winding table 535 is a relationship table that specifies which windings are to be paired with one another in a coil circuit.

An element table 505 and an AdjEle table 510 together specify the physical relationship of the elements in a coil for the pattern identifier specified. A calculation table 525 stores the equations to determine the dielectric values of the elements, and the turns calculations for each segment. The element table 505 and a segment table 540 are linked to the calculation table 525. The segment table 540 is related to the winding table and specifies which segments belong to which windings and also specifies which calculation record(s) are to be used in calculating the segment turns.

Thus, an end user not skilled in computer programming is able to create patterns. For example, an expert transformer designer, who typically has little skill in computer programming, can create patterns without having to explain them to a programmer.

While exemplary embodiments of the present invention have been described in connection with various computing devices, the underlying concepts may be applied to any computing device or system.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims.

1. A method of generating a coil structure pattern, comprising:
receiving at least one pattern or sub-pattern;
assembling a layout comprising the at least one pattern or sub-pattern;
providing at least one of a parameter value, an attribute, and metadata to the at least one pattern or sub-pattern disposed in the assembled layout; and
generating a coil structure pattern based on the layout and the at least one parameter value, attribute, and metadata.

2. The method of claim 1, further comprising storing the coil structure pattern in a storage device.

3. The method of claim 1, wherein receiving the at least one pattern or sub-pattern comprises retrieving the at least one pattern or sub-pattern from a storage device.

4. The method of claim 1, wherein assembling the layout comprises arranging the at least one pattern or sub-pattern pursuant to commands received via a user interface.

5. The method of claim 1, wherein the assembled layout comprises at least one element selected from the group consisting of a circuit set, a circuit schematic, and a circuit layout.

6. The method of claim 1, wherein the coil structure pattern comprises at least one circuit layout and one circuit schematic.

7. The method of claim 1, wherein the metadata comprises mandatory metadata and optional metadata.

8. The method of claim 1, wherein the metadata comprises a pattern identifier, a pattern description, and a pattern type.

9. The method of claim 1, wherein generating the coil structure pattern is performed at runtime.

10. A computer-readable medium having computer-executable instructions for performing the steps recited in claim 1.

11. A coil pattern creation system, comprising:
a storage device storing at least one of a pattern and a sub-pattern;
a pattern design system for receiving at least one pattern or sub-pattern from the storage device and assembling a layout comprising the at least one pattern or sub-pattern; and
a user interface coupled to the pattern design system for providing at least one of a parameter value, an attribute, and metadata to the at least one pattern or sub-pattern disposed in the assembled layout, the pattern design system generating a coil structure pattern based on the layout and the at least one parameter value, attribute, and metadata.

12. The system of claim 11, wherein the storage device is adapted to store the coil structure pattern.

13. The system of claim 11, wherein the pattern design system assembles the layout based on commands received via the user interface.

14. The system of claim 11, wherein the assembled layout comprises at least one element selected from the group consisting of a circuit set, a circuit schematic, and a circuit layout.

15. The system of claim 11, wherein the coil structure pattern comprises at least one circuit layout and one circuit schematic.

16. The system of claim 11, wherein the metadata comprises mandatory metadata and optional metadata.

17. The system of claim 11, wherein the metadata comprises a pattern identifier, a pattern description, and a pattern type.

18. A computer-readable medium having stored thereon a data structure, comprising:
a first data field comprising a pattern table with a pattern identifier;
a second data field comprising nominal voltage data associated with the pattern identifier; and
a third data field comprising data regarding the physical relationship of elements in a coil for the pattern identifier.

19. The computer-readable medium of claim 18, further comprising a fourth data field comprising calculation data for determining the dielectric values of the elements.

20. The computer-readable medium of claim 19, further comprising a fifth data field comprising element data and segment data linked to the fourth data field to specify which segments belong to which windings and specify which calculation records are to be used in calculating the segment turns.

21. The computer-readable medium of claim 18, further comprising a node data field for linking the nominal voltage data to node point records residing in a node point data field.
